(19) United States
(12) Patent Application Publication
(10) Pub. No.: US 2022/0144218 A1
(43) Pub. Date: May 12, 2022

(54) METHOD FOR CLEANING AN OPTICAL SURFACE OF A MOTOR VEHICLE

(71) Applicant: Valeo Systèmes d'Essuyage, Le Mesnil Saint Denis (FR)

(72) Inventors: Frédéric Bretagnol, Issoire (FR); Adrien Peret, Issoire (FR); Baptiste Beziat, Issoire (FR)

(73) Assignee: Valeo Systèmes d'Essuyage, Le Mesnil Saint Denis (FR)

(21) Appl. No.: 17/418,575

(22) PCT Filed: Dec. 17, 2019
(86) PCT No.: PCT/EP2019/085597

§ 371 Date: Jun. 25, 2021

(30) Foreign Application Priority Data
Dec. 26, 2018 (FR) 1874194

(51) Int. Cl. B60S 1/56; B60S 1/48; B08B 3/02; B08B 3/10; B08B 13/00

(52) U.S. Cl. CPC B60S 1/56; B60S 1/488; B08B 2203/007; B08B 3/10; B08B 13/00; B08B 3/02

(57) ABSTRACT

The invention relates to a method for automated cleaning of an optical surface of a motor vehicle, comprising at least one cycle of cleaning (38) the optical surface which comprises a plurality of separate and successive steps of spraying fluid, said cycle of cleaning (38) comprising at least a first step of spraying (30) cleaning fluid onto the optical surface, a second step of spraying (32) cleaning fluid onto the optical surface, and a break step (34), of non-zero duration, between the first step of spraying (30) cleaning fluid and the second step (32) of spraying cleaning fluid.

The technical field of the invention is that of devices for cleaning an optical surface of a motor vehicle, and more particularly devices for cleaning a surface of an optical sensor with which such a motor vehicle is equipped.

Motor vehicles increasingly comprise automated systems, including especially driving assistance systems which can make it possible, in a lesser degree of autonomy of the vehicle, to assist with or to perform parking maneuvers as well as to carry out, in a maximum degree of autonomy of the vehicle, driving of the vehicle without a driver being present in the vehicle. Such driving assistance systems comprise especially one or more detection devices which are equipped with optical sensors capable of detecting an environment of the vehicle and capable of evaluating parameters external to that vehicle. The optical sensors are associated with at least one control unit which is configured to interpret the information so collected and to take the decisions which are necessary as a consequence of that information.

More particularly, the use of autonomous vehicles, without a driver, involves the use of a plurality of optical sensors which are arranged all around the vehicle, so that the control unit has a very precise image of the environment of the vehicle, which image is at least as reliable as the three-dimensional image which a driver may obtain himself.

For example, an optical sensor can be positioned at the rear of the vehicle in order to allow the driver to have a better view of the obstacles that are behind the vehicle when he is executing a parking maneuver. The optical sensors are thus generally positioned outside the vehicle, exposed to bad weather, dust and/or debris such as, for example, mud splashes or insects which become squashed against the optical surface of the sensor, especially under the effect of the speed of the vehicle. Over time, the field of detection of such a sensor may therefore be wholly or partially obstructed by such soiling, and it is then found to be necessary to regularly clean the optical surface of the sensor in order to allow it to fulfil its function.

Such cleaning can be carried out with the aid of a cleaning liquid which is sprayed under pressure onto the optical surface in question. Depending on the nature of the soiling, a more or less large amount of cleaning liquid will have to be used for an uncertain result. Indeed, some types of soiling, such as, for example, mud or insect residues, may not be removed completely after a spraying of fluid and may require intervention by the driver in order to manually remove the elements that adhere most firmly. Increasing the pressure may be effective, but it requires a large amount of fluid. It is also possible to use a specific cleaning fluid which is capable of allowing insect residues, for example, to dissolve more effectively, but it will be appreciated that the use of such specific liquids is costly and may require a specific architecture with especially a plurality of storage reservoirs.

Furthermore, in order to increase the effectiveness of such cleaning, it is possible to heat the cleaning liquid before it is sprayed onto the surface of the sensor. Although such a solution may be found to be effective, for example, in winter, that is to say when the outside temperature is low, for resistant traces, such as traces of mud, its effectiveness remains questionable, for example in summer, that is to say when the outside temperature is high, for removing soiling such as insects.

The object of the present invention is to propose a cleaning solution which is simple, inexpensive and effective in all situations of cleaning of an optical surface of a sensor as defined hereinbefore, whatever the type and amount of soiling that is present on the surface.

To that end, the present invention relates to a method for automated cleaning of an optical surface of a motor vehicle, comprising at least one cycle of cleaning the optical surface which comprises a plurality of separate and successive steps of spraying fluid, said cycle of cleaning comprising at least a first step of spraying cleaning fluid onto the optical surface, a second step of spraying cleaning fluid onto the optical surface, and a break step, of non-zero duration, between the first step of spraying cleaning fluid and the second step of spraying cleaning fluid.

Preferably, but not exclusively, the invention is applicable to the automated cleaning of an optical surface of an optical sensor which is used in the implementation of a driving assistance system: by way of non-limiting examples, such a sensor may be a photograph camera (in this case the sensor may be, for example, a lens of such a camera) or any other sensor designed to detect information of a visual nature and to transmit said information to a control unit of the vehicle. Optical surface is therefore here understood as meaning a surface of such a sensor that is active for the detection: it may be, for example, the glass surface of a lens or the surface that is transparent to electromagnetic radiation of a device of the LIDAR type, for example. In the following, the optical surface will also be referred to as the optical surface of the sensor in question. Method for automated cleaning is understood as meaning a method whose parameters are defined by a control unit as a function of data retrieved by that same control unit. It is distinct from a manual cleaning operation in which it is the driver who decides, according to his perception, on a sequence of cleaning and spraying fluid.

According to the invention it is noteworthy that the method implements in succession two separate steps of spraying in the sense that they take place in a time-deferred manner, and that the method additionally provides a consequent break time which prevents the second step of spraying from following immediately after the first step of spraying. The break time, of non-zero duration, interrupts the spraying of fluid in order to give the fluid sprayed in the first instance time to act on the soiling and to modify the structure thereof, especially by wetting it for a consequent period of time.

According to a feature of the invention, the method for cleaning comprises a step of detecting a level of soiling on the optical surface, it being possible for the characteristics, especially the duration, of the first step of spraying, of the break step and of the second step of spraying to vary according to the level of soiling detected. In particular, it can be provided that the duration of the break step is modified in order to assist with the impregnation of the fluid sprayed in the first step of spraying.

In this context, the detection of a level of soiling on the optical surface can be carried out by comparing information detected by the sensor with reference information, for example stored in a control unit of a cleaning system of the sensor. Such information can, for example, in the case where the sensor in question is an optical sensor, be an image taken by the sensor.

According to another example, the detection of a level of soiling on the optical surface of the sensor can be carried out by comparing two pieces of information detected in succession by the sensor at a predefined time interval, such a comparison being carried out, for example, in a control unit as mentioned hereinbefore. In the case where the sensor in question is an optical sensor, the comparison may be, for example, the comparison of two successive images taken at a predefined time interval.

Advantageously, the cycle of cleaning the optical surface of the sensor is initiated as soon as the recorded level of soiling is greater than a predefined threshold. It must therefore be understood here that a cleaning system which carries out a method according to the invention comprises at least one control unit in which the information detected by the sensor is stored, as well as means for comparing the stored pieces of information with one another and/or with one or more predefined reference pieces of information. According to one example, such comparison means may comprise means for processing an image in order to determine the sharpness and precision thereof. Accordingly, the cycle of cleaning defined hereinbefore can be initiated as soon as a sharpness and/or a precision of such an image is below a predefined sharpness and/or precision.

According to another example, the above-mentioned cycle of cleaning can be initiated as soon as an anomaly is noted in the information detected. More specifically, in the case where the sensor in question is an optical sensor, the above-mentioned cycle of cleaning can be initiated as soon as, for example, the presence of an undetected zone is noted. Such a case is the case where a spot whose size exceeds a predefined threshold is detected on a photograph taken by means of an optical sensor, which spot is the result of, for example, the presence of a squashed insect. In such a case, an overall level of soiling on the surface of the sensor in question may remain below a predefined threshold, the image nevertheless having an obscure region whose presence is detrimental to the quality of the detection which is performed.

As has been specified, according to the invention the cycle of cleaning comprises in succession a first step of spraying a cleaning fluid onto the optical surface of the sensor in question, a break step of non-zero duration, followed by a second step of spraying a cleaning fluid onto the optical surface of the sensor in question.

The cleaning fluid is here preferably a liquid or a mixture of liquids which are chosen, for example, for their detergent properties. According to one example, the cleaning fluid sprayed in the first step of spraying and the cleaning fluid sprayed in the second step of spraying are identical. According to another example, the cleaning fluid sprayed in the first step of spraying has, for example, surface-active properties which are different from those of the cleaning fluid sprayed in the second step of spraying, such that the chemical action of the cleaning fluid sprayed in the first step of spraying is superior to that of the cleaning fluid sprayed in the second step of spraying.

Whatever the nature of the cleaning fluid or fluids sprayed in the two above-mentioned steps of spraying, the invention provides that a break time of non-zero duration separates the two steps of spraying. Advantageously, this break time has a minimum duration of the order of two seconds. Preferably, the duration of this break time is of the order of five seconds.

As described hereinbefore, the break step allows prolonged impregnation of the optical surface of the sensor with the cleaning fluid sprayed in the first step of spraying is carried out, thus allowing, for example, a first dissolution of the soiling present on the optical surface.

In the second step of spraying cleaning fluid, the soiling dissolved in the break step is removed by the cleaning fluid, thus improving the effectiveness of the cleaning operation. Accordingly, the invention makes it possible, by simple means, to remove adherent soiling from the optical surface of the sensor, the removal of which soiling, without carrying out the method according to the invention, would require a manual mechanical intervention.

It should be noted that the invention extends to a method comprising a plurality of steps of spraying and, where appropriate, of steps of detecting a level of soiling on the optical surface of the sensor. More specifically, the invention extends to a method in which a first step of detecting a level of soiling is carried out and generates the implementation of the two steps of spraying separated by the break time, in which a new step of detecting a level of soiling is carried out following the steps of spraying, and in which, at the end of this second step of detecting a level of soiling, a new sequence of a first step of spraying cleaning fluid, a break step and a second step of spraying cleaning fluid is carried out.

The invention may also have one or more of the following features, taken individually or in combination:

a duration of the break step is greater than a duration of the first step of spraying cleaning liquid. This makes it possible to increase the effectiveness of the impregnation mentioned hereinbefore, for optimal cleaning with an amount of fluid that is controlled more effectively.

a duration of the first step of spraying cleaning fluid is less than or equal to a duration of the second step of spraying cleaning fluid. According to one example, a duration of the first step of spraying cleaning liquid is substantially of the order of one second.

a pressure of the cleaning fluid sprayed onto the surface of the sensor in the first step of spraying is less than or equal to a second pressure of the cleaning fluid sprayed onto the surface of the sensor in the second step of spraying. The function of the first step of spraying is not to remove the soiling under the effect of the spraying pressure but to impregnate the soiling with fluid in order to facilitate the cleaning effect in the second step of spraying. It is therefore not necessary to provide a high fluid spraying pressure in this first step, and this falls within the context of saving sprayed fluid, which may be all the more valuable if the fluid used in the first step of spraying is a fluid with specific chemical properties.

a pressure of the cleaning fluid sprayed in the first step of spraying is less than or equal to 3 bar.

a step of heating the cleaning fluid or fluids sprayed onto the optical surface of the sensor is carried out at least prior to the initiation of the cycle of cleaning. A synergy is to be noted between the heating of the sprayed fluid and the break time left between the two steps of spraying fluid. Accordingly, the effectiveness of the impregnation with the sprayed fluid and its role in dissolving the soiling on the optical surface is better when the fluid is heated.

the step of heating is carried out such that the temperature of the fluid sprayed in the first step of spraying is greater than or equal to the temperature of the fluid sprayed in the second step of spraying. It should be noted that the effect of heating the sprayed fluid is substantially desirable in the period covering the first step of spraying and the break time, and therefore for the temperature of the fluid sprayed in the first step of spraying, such that it may be provided to discontinue heating at the same time as the first step of spraying is interrupted without this being detrimental to the invention.

the step of heating is carried out continuously as soon as the vehicle is started, the temperature of the cleaning fluid being maintained at a substantially constant temperature.

According to an advantageous example, a temperature of the cleaning fluid sprayed in the first step of spraying is greater than 20° C., for example greater than 30° C. Heating the cleaning fluid sprayed onto the optical surface of the sensor makes it possible to increase both the chemical effectiveness of the cleaning fluid on the soiling to be removed and its effectiveness in dissolving that soiling.

the method according to the invention comprises a step of analyzing the need for cleaning of the optical surface, comprising at least a step of detecting a speed of movement of the vehicle and/or a step of detecting an outside temperature. Indeed, the presence of soiling on an optical surface of the sensor in question can be increased when the vehicle is moving at high speed. The invention can then provide, for example, that the time interval that separates the detection of two successive pieces of information for defining a level of soiling is reduced when the speed of movement of the vehicle is increased. Analogously, the presence of soiling on an optical surface of the sensor in question can be increased when the vehicle is travelling in summer. The invention can then provide, for example, that the time interval that separates the detection of two successive pieces of information for defining a level of soiling is reduced when the outside temperature is above a certain threshold.

The invention extends also to a system for cleaning an optical surface of a sensor of a motor vehicle, comprising at least:

a device for spraying a cleaning fluid, which device is configured to carry out, at non-zero time intervals, different steps of spraying the cleaning fluid,

a control unit which is configured to generate control instructions for the spraying device and to control at least one step of the cleaning method as described hereinbefore.

The cleaning system can further comprise a module for heating a cleaning fluid, which module is configured to bring a cleaning fluid to at least a predefined temperature, an outside temperature sensor and/or a vehicle speed sensor, a processing unit configured to determine a level of soiling on the optical surface, said control unit being configured to generate said control instructions as a function of received data coming from a sensor or from the processing unit.

Other features and advantages of the present invention will become more clearly apparent from the description and the drawings, in which:

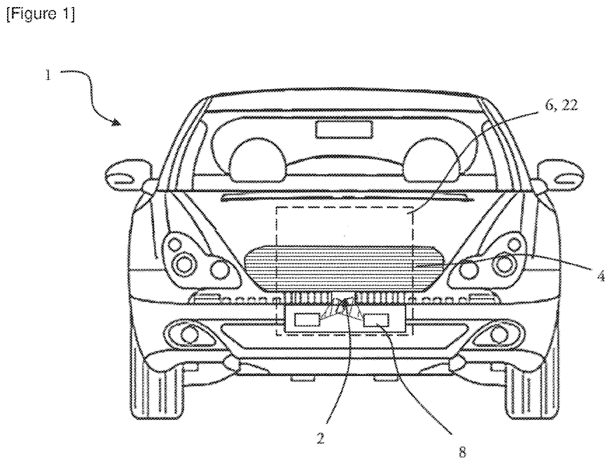

FIG. 1 is a schematic representation of a motor vehicle equipped with means for carrying out a cleaning method according to the invention;

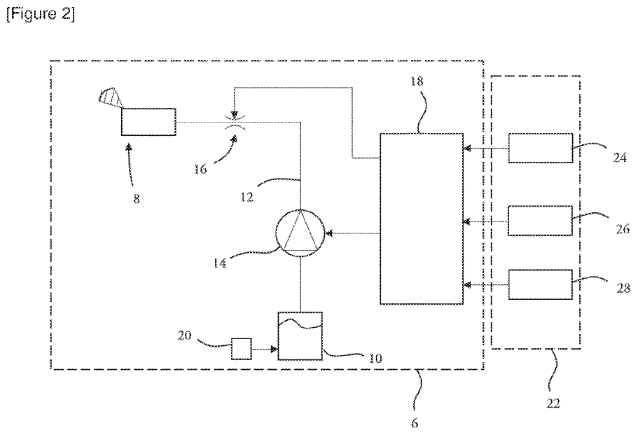

FIG. 2 is a detail view of those means, showing schematically a control unit which is capable of receiving information from temperature, speed and level of soiling sensors of a sensor and capable of generating, as a consequence, control instructions for a pump and a controlled valve in order to control especially the duration of phases of spraying fluid;

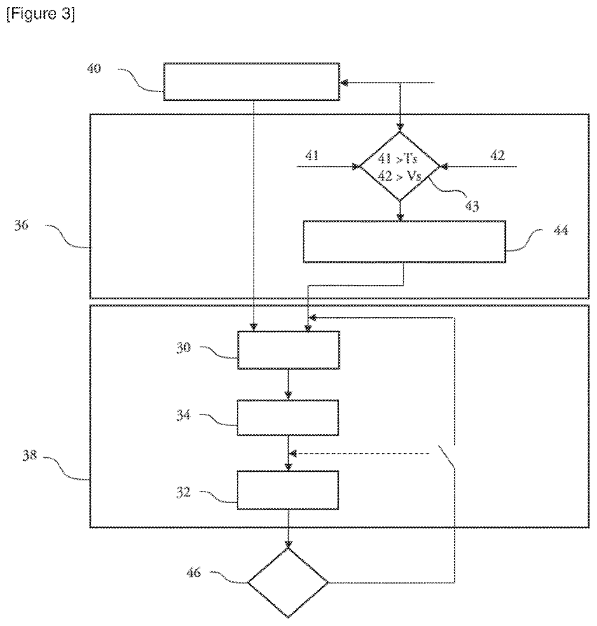

FIG. 3 is a schematic illustration of the various steps of a method according to the invention, and

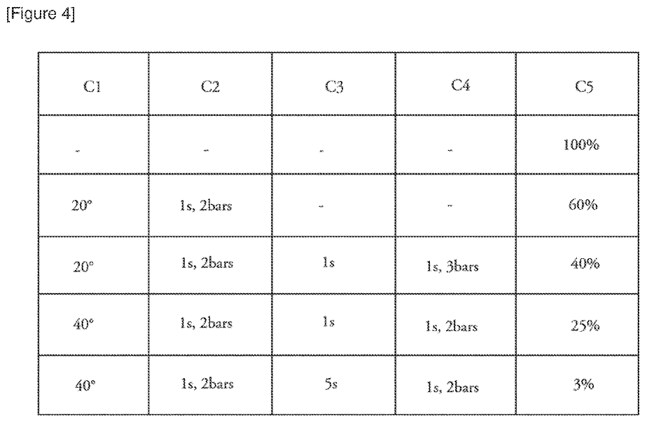

FIG. 4 is a summary table of tests of the cleaning method with different parameters, especially duration parameters, of the steps of the method.

It should first of all be noted that although the figures set out the invention in detail for its implementation, said figures may, of course, be used in order better to define the invention if necessary. However, it should be noted that these figures only set out some of the possible exemplary embodiments of the invention.

A vehicle 1, illustrated in [FIG. 1], comprises a driving assistance system, comprising at least one optical sensor 2, here a vision camera, which, without departing from the scope of the invention, may consist of a detection device of the LIDAR or RADAR type.

The optical sensor 2 is here arranged at the front of the vehicle, in the region of the radiator grill 4, but it will be appreciated that it may be situated at the rear of the vehicle, on the sides of the vehicle or on the roof, again without departing from the scope of the invention.

The optical sensor 2 is associated with a cleaning system 6 which is capable of removing the soiling from a glass surface of the optical sensor and which comprises at least one device for spraying fluid.

More particularly, the cleaning system 6 comprises at least one cleaning fluid reservoir 10 and at least one spraying device 8, in the form of a spray nozzle, for example, by means of which the cleaning fluid can be sprayed in the direction of the glass surface of the optical sensor. The cleaning system additionally comprises at least one distribution pipe 12 which connects the reservoir(s) to the spray nozzle(s), and means for controlling the supply of cleaning fluid comprising especially at least one pump 14 and a controlled valve 16.

It will be appreciated that the pump 14 is arranged at the outlet of the fluid reservoir 10 so as to carry the fluid sent in the direction of the spraying device at a determined pressure, and that the controlled valve 16 is arranged upstream of the spraying device 8 so as to permit or prevent the passage of fluid in the direction of the spray nozzle.

The cleaning system 6 additionally comprises a control unit 18 which is configured to control the cleaning system 6 in accordance with an appropriate sequence, this sequence being able to be implemented or modified, where appropriate, as a function of the environmental conditions or of the detection of a level of soiling on the optical sensor.

The cleaning system 6 comprising at least one spraying device 8 for spraying cleaning fluid onto the optical surface may, where appropriate, in a variant not shown here, comprise an additional cleaning device, for example a wiper blade which can clean the optical surface after the cleaning fluid has been sprayed.

The cleaning fluid reservoir comprises a heating module 20 for heating the fluid, which module can be operated on ignition of the vehicle and is dimensioned to impart a first operating temperature, for example 20°, to the fluid. Alternatively, the heating module 20 can be configured to impart a plurality of different temperatures to the cleaning fluid, including a first temperature, for example equal to 20°, and a second temperature, for example equal to 40°.

The vehicle additionally comprises a system for analyzing the need for cleaning 22 of the sensor, which system comprises different sensors or data processing units which are configured to send information to the control unit 18 of the cleaning system, said information being obtained by the processing of outside temperature data and/or vehicle speed data for the detection of driving conditions which are favorable to the appearance of soiling which must be cleaned by the cleaning method of the invention, or on the basis of the processing of the images acquired by the optical sensor in order to analyze a level of soiling present on the optical surface. In the example illustrated in [FIG. 2], the sensors or processing units of the analysis system 22 communicate directly with the control unit, but it is of course possible that a processing module may synthesize data within the analysis system 22 in order to send a single piece of information to the control unit of the cleaning system 6.

This system for analyzing the need for cleaning 22 can accordingly comprise an outside temperature sensor 24, in order especially to detect whether the vehicle is driving during a summer period, by comparing the measured outside temperature with a threshold temperature value which is equal, for example, to 20°.

Alternatively or cumulatively, the system for analyzing the need for cleaning 22 can also comprise a vehicle speed sensor 26, which is intended especially to send information according to which the vehicle is travelling at high speed, for example on a freeway, by comparing the measured speed with a threshold speed value which is equal, for example, to 100 km/h.

Without departing from the scope of the invention, it can be provided that the information relating to the temperature and/or the information relating to the speed is obtained by a sensor that is specific to the system for analyzing the need for cleaning, or is obtained via an overall control system of the vehicle which already holds this information for other applications.

The system for analyzing the need for cleaning 22 can also comprise, alternatively or cumulatively, image analysis and processing means 28, which is configured to retrieve the image acquired by the sensor at time T and to compare that image with the image acquired at the preceding time T-AT. The comparative analysis of these two images, pixel by pixel, makes it possible to detect a level of soiling on the optical surface by examining the appearance of a dark zone on the acquired image, this dark zone revealing soiling, whether it is, for example, a trace of mud or a squashed fly.

As will be understood from the above, the control unit 18 of the cleaning system 6 of the sensor is configured to carry out control of the cleaning method, especially by putting in place an appropriate operating sequence of the spray nozzles, and, where appropriate, to influence the cleaning method as a function of the information retrieved by the system for analyzing the need for cleaning.

The cleaning method implemented by the control unit 18 is specific especially in that a first step of spraying fluid 30 is controlled, for a predetermined duration, with a fluid at a given temperature and pressure, and in that a second separate step of spraying 32 is implemented subsequently, with a fluid sprayed at a given temperature and pressure, the second step of spraying 32 being carried out after a subsequent break time 34 that is sufficient that the fluid sprayed in the first step of spraying 30 has an impregnating action on the soiling present on the optical surface of the sensor.

In the method according to the invention, the function of the liquid sprayed in the first step of spraying step 30 is accordingly to wet the optical surface of the sensor without necessarily removing soiling therefrom, while the function of the break time 34, which begins at the time of interruption of the first step of spraying 30, is to allow the fluid sprayed beforehand in the first step 30 to impregnate the optical surface and modify the structure of the soiling that is present, and the function of the second step of spraying 32 is to clean the glass surface by removing the soiling.

An example of a cleaning method is described more particularly with reference to [FIG. 3], it being understood that, in this example of the method, the control unit 18 implements in succession a step of analyzing the need for cleaning 36 and an actual cycle of cleaning 38, following a step of initial heating 40 of the cleaning fluid. As has been mentioned hereinbefore, the cleaning method according to the invention comprises at least said cycle of cleaning 38.

When the vehicle is started, a step of heating 40 the cleaning fluid is carried out so as to bring the cleaning fluid to a temperature which is equal to a specific value, for example 20° C. Heating of the fluid is controlled so that the cleaning fluid is brought to that temperature and is maintained at that temperature throughout the cleaning method.

Simultaneously, in a step of analyzing the need for cleaning 36, as soon as the vehicle is started, two pieces of information are retrieved, here via a sensor appropriate to each of the measurements, namely a first piece of information 41 relating to the outside temperature T and a second piece of information 42 relating to the speed V of the vehicle. Each of these pieces of information is compared, in a first analysis sub-step 43, with a threshold temperature value Ts and with a threshold vehicle speed value Vs, respectively.

In the illustrated example, this first analysis sub-step 43 indicates at the output a need for cleaning when on the one hand the outside temperature is above the temperature threshold value Ts, for example 20° C., which reflects a summer situation during which the risk of insects being squashed on the optical surface of the sensor is increased, and when on the other hand the speed of the vehicle is above the speed threshold value Vs, for example 100 km/h, which reflects a situation of travelling at high speed on a freeway during which the risk of insects being squashed on the optical surface is again increased.

A second analysis sub-step 44 consists in analyzing the level of soiling on the optical surface of the sensor, especially by employing the image processing means provided and mentioned hereinbefore. The result can either be compared with a threshold value in order to define whether a cleaning cycle is necessary, which can be the case, for example, if the rate of soiling is greater than 20%, or can be taken into account in order to modify one of the parameters of the cycle of cleaning that is to follow, and especially the duration of the break time.

The cycle of cleaning 38 comprises, as specified hereinbefore, a first step of spraying cleaning fluid 30. The controlled valve 16 is activated for a specific period of time, of the order of one or more seconds, in order to allow the cleaning fluid to pass to the spraying device 8.

At the end of this specific period of time, the control unit 18 stops the supply of cleaning fluid to the spraying device 8 so as to interrupt the first step of spraying 30. A break time 34 in the spraying is implemented, for a specific duration which is greater than two seconds according to the invention.

At the end of this break time 34, during which the fluid sprayed beforehand in the first step of spraying 30 spreads over the optical surface and impregnates the soiling present on the surface, the control unit 18 generates control instructions for the pump 14 and the controlled valve 16 in order to carry out the second step of spraying 32. There too, the controlled valve 16 is activated for a specific period of time, of the order of one or more seconds, in order to allow the cleaning fluid to pass to the spraying device 8.

After this second step of spraying 32, a checking operation 46 can be carried out, in which the level of soiling is checked. Depending on the response to the test that is carried out in this checking operation 46, the control unit 18 may decide that the cycle of cleaning 38 must resume. According to the rate of soiling detected, the cycle of cleaning 38 can be reinitiated at the first step of spraying 30 or at the second step of spraying 32 (dotted line in [FIG. 3]).

FIG. 4 illustrates the result of research carried out by the inventors for the selection of the essential features of the method according to the invention, the table being read as follows.

A first column C1 indicates the temperature of the cleaning liquid sprayed onto the glass surface.

A second column C2 indicates the spraying characteristics of the cleaning liquid in the first step of spraying 30, namely the duration of spraying and the pressure of the sprayed liquid.

A third column C3 indicates the characteristics of the break step 34, in which no fluid is sprayed, in a duration determined so as to allow the cleaning fluid sprayed in the first step of spraying 30 to act on the glass surface.

The break step 34 is significant in the context of the invention in the sense that it lasts at least two seconds (2s). This duration of two seconds has thus been established by the work carried out by the inventors as a minimum duration for the fluid sprayed in the first step of spraying 30 to have an effect on the soiling present on the glass surface.

The fourth column C4 indicates the spraying characteristics of the cleaning liquid in the second step of spraying 32, namely the duration of spraying and the pressure of the sprayed liquid.

In this exemplary embodiment, the fluid sprayed in the second step of spraying 32 is the same as the fluid sprayed in the first step. It should, however, be noted that the sprayed fluids may differ from one step of spraying to the other. In particular, a first fluid sprayed in the first step may consist of a specific fluid, for example an anti-mosquito fluid, while the second fluid sprayed in the second step, which is used to clean the surface after impregnation of the first liquid, may be only water.

The table of [FIG. 4] reports different tests conducted by the inventors, with combinations of different characteristics in each of the steps, and shows for each of these tests the result of the cleaning method in the fifth column C5, with reference to an initial soiling situation on the optical surface of the order of 100%.

In a first test conducted by the inventors, which was used as a reference test, a cleaning fluid, heated to a temperature of 20° C., was used in a single step of spraying, for a duration of one second, with the cleaning fluid at a pressure of 2 bar. This results in a passable level of cleaning, with an optical surface of which 60% remains soiled.

In a second test conducted by the inventors, carrying out the cleaning method according to the invention, the same cleaning fluid was used throughout the duration of the method at a temperature of 20° C. The first step of spraying 30 was carried out for a duration of one second with a first cleaning fluid at a pressure of 2 bar. The break time 34 was observed for one second, before the second step of spraying 32, which was carried out for a duration of one second with the cleaning fluid this time at a pressure of 3 bar. This results in a reduction in the level of soiling, such that 40% of the optical surface is soiled. The effectiveness of providing a break step and a second step of spraying in succession, following an interruption in a first step of spraying, will thus be appreciated.

A third test allows the value of heating the cleaning fluid to be highlighted, by proposing a sequence similar to that carried out in the second test with the cleaning fluid heated to a second temperature of 40° C., and with a pressure of the cleaning fluid in the second step of spraying which is reduced to 2 bar. This results in a reduction in the level of soiling, such that 25% of the optical surface is soiled.

A fourth test shows an even greater improvement in the results, this time focusing on the duration of the break time. The temperature of the cleaning fluid was again 40° C., the first step of spraying was again carried out for a duration of one second, with a first cleaning fluid at a pressure of 2 bar. The break time was this time observed for a duration of five seconds, before the second step of spraying, which was carried out for a duration of one second with the cleaning fluid this time at a pressure of 2 bar. This results in a pronounced reduction in the level of soiling, such that the optical surface is almost clean, with a rate of soiling of approximately 3%.

The work carried out by the inventors has thus made it possible to highlight the fact that the duration of the break time is particularly important, in order to allow the fluid sprayed in the first step to act. The optimal break time is here five seconds, but it has additionally been found, via other tests not shown here, that a break time of a duration at least equal to two seconds produces valuable effects.

This break time, of the order of a few seconds, can especially be longer than the duration of the spraying of fluid during the first step and/or during the second step.

The present invention thus proposes a method which is simple and inexpensive to carry out and which allows the quality of the cleaning of the optical surfaces of sensors in motor vehicle detection systems to be improved. In particular, the method is simple to carry out in that it consists mainly in implementing a consequent break time by interrupting a first step of spraying fluid and then resuming, after the break, with a second step of spraying fluid which can have different spraying characteristics. The method is also inexpensive in that it allows the quantity of fluid sprayed in order to achieve an optimal cleaning quality to be controlled. It is in fact no longer necessary to spray copious amounts of fluid in order in the end to clean the surface and remove the soiling therefrom, the present invention aiming on the contrary to spray a controlled amount of fluid in a first step and then allow it to act on the soiling in a break step in which the spraying of fluid is stopped.

The present invention is not limited to the means and configurations described and illustrated herein, however, but also extends to all equivalent means or configurations and to any technically functional combination of such means. In particular, the means described here for deciding whether or not to implement the cleaning steps and the intermediate break step may be modified without detriment to the invention insofar as the cleaning method maintains alternating spraying phases and break phases as described hereinbefore.

1. A method for automated cleaning of an optical surface of a motor vehicle, comprising:
at least one cycle of cleaning the optical surface which comprises a plurality of separate and successive steps of spraying fluid,
said cycle of cleaning comprising at least a first step of spraying cleaning fluid onto the optical surface, a second step of spraying cleaning fluid onto the optical surface, and a break step, of non-zero duration, between the first step of spraying cleaning fluid and the second step of spraying cleaning fluid.

2. The method as claimed in claim 1, in which a duration of the break step is at least equal to two seconds.

3. The method as claimed in claim 1, wherein a duration of the break step is greater than a duration of the first step of spraying cleaning fluid.

4. The method as claimed in claim 1, wherein a duration of the first step of spraying cleaning fluid is less than or equal to a duration of the second step of spraying cleaning fluid and/or a pressure of the cleaning fluid sprayed onto the optical surface in the first step of spraying is less than or equal to a second pressure of the cleaning fluid sprayed onto the optical surface in the second step of spraying.

5. The method as claimed in claim 4, in which a pressure of the cleaning fluid sprayed in the first step of spraying is less than or equal to 3 bar.

6. The method as claimed in claim 1, in which a step of heating fluid is carried out at least prior to the initiation of the cycle of cleaning.

7. The method as claimed in claim 6, in which the step of heating is carried out such that the temperature of the fluid sprayed in the first step of spraying is greater than or equal to the temperature of the fluid sprayed in the second step of spraying.

8. The method as claimed in claim 1, comprising a step of analyzing the need for cleaning of the optical surface, comprising at least a step of detecting a speed of movement of the vehicle and/or a step of detecting an outside temperature and/or a step of detecting a level of soiling of the optical surface.

9. A cleaning system for a surface of a sensor of a motor vehicle, comprising:
a device for spraying a cleaning fluid, which device is configured to carry out, at non-zero time intervals, different steps of spraying the cleaning fluid,
a control unit which is configured to generate instructions for controlling the spraying device and to control at least one step of the cleaning method according to claim 1.

10. The cleaning system as claimed in claim 9, further comprising:
a heating module for heating a cleaning fluid, which module is configured to bring a cleaning fluid to at least a predefined temperature,
an outside temperature sensor and/or a vehicle speed sensor,
a processing unit configured to determine a level of soiling of the optical surface, the control unit being configured to generate said control instructions as a function of received data coming from the outside temperature sensor and/or from the vehicle speed sensor and/or from the processing unit.
